(19) United States
(12) Patent Application Publication
(10) Pub. No.: US 2013/0219838 A1
(43) Pub. Date: Aug. 29, 2013

(54) Hoof Sock Bandage

(71) Applicant: Jeannette Swearingen, Huntsville, AL (US)

(72) Inventor: Jeannette Swearingen, Huntsville, AL (US)

(21) Appl. No.: 13/882,202

(22) PCT Filed: Oct. 29, 2011
(86) PCT No.: PCT/US11/58481

§ 371 Date: Apr. 29, 2013

Related U.S. Application Data
(60) Provisional application No. 61/408,615, filed on Oct. 31, 2010.

(51) Int. Cl. B68C 5/00; B05D 1/02; B05D 1/18; B05D 3/00

(52) U.S. Cl. CPC B68C 5/00; B05D 3/007; B05D 1/02; B05D 1/18
USPC 54/82; 427/398.1; 427/331

(57) ABSTRACT

A one piece hoof sock bandage for use with horses, livestock, and other hoofed animals includes an elastic, water resistant sock material having a sole portion coated with a resilient, puncture resistant material. The sock material provides uniform compression to avoid constriction and extends up the leg to the pastern or higher where it is held in place by a cuff portion. The resilient sole portion covers the sole of the hoof and extends up the wall of the hoof far enough to prevent the sole portion from sliding on the hoof and to protect as much of the hoof as desired. The sock and sole portions may contain medications in various forms and generally function to treat the hoof area and protect it from contamination.

### RELATED APPLICATION

This application claims the benefit of priority to U.S. application Ser. No. 61/408,615, filed Oct. 31, 2010 and which is incorporated by reference in its entirety.

### BACKGROUND OF THE INVENTION

1. Field of the Invention

The present invention relates to products and methods for the treatment of hooves and lower legs of livestock and other hoofed animals and more particularly to a slip-on treatment and protection system. The products, methods, and systems are useful for the prevention and/or treatment of hoof and lower leg ailments and injuries on horses, ponies, donkeys, mules, zebras, and other livestock and wild hoofed animals.

2. Description of Related Art

Protecting the hooves of a horse an other livestock is a vital part of caretaking. Common equine hoof ailments, for example, include abscesses, punctures and stone bruises. These can be painful, recurring, and even debilitating and, left unattended or poorly tended, can lead to death. Hoof and leg injuries or ailments must, in most cases, be kept clean and free from dirt, debris and manure in order to prevent infection and promote healing. This is frequently accomplished using one or more bandages. Securing a bandage onto a horse hoof for periods as long as 24 hours or more as the horse moves about in a stall or pasture requires specialized skills and is time consuming.

Existing hoof and lower leg coverings usually require the use of duct tape, vet wrap, or straps that can hinder leg movement, inhibit blood circulation, damage the coronet band of the hoof, and/or prevent air circulation. Duct tape or elastic adhesive tape holds well under most circumstances but their removal can cause problems, including the need for cutting with sharp edges, which is hazardous to the caregiver and animal alike. Removal of tape can also injure the skin when it is adhered to hair or bare skin. Removal of vet wrap is time consuming and, if done improperly, can contaminate a wound or lesion with dirt or manure deposited on the wrap. Furthermore, the use of tape or vet wrap is difficult because it often requires holding the horse's hoof up long enough to apply the tape.

During treatment, leaving the bottom surface of the hoof uncovered makes the hoof susceptible to damage by objects on the ground and contamination of the treatment site. Medication boots, tape, or wraps are often used to cover the bottom surface of the hoof. Boots are durable but they do not extend beyond the hoof, which risks contamination of the treatment area. Boots secured using straps, clasps, elastic bands, and the like apply unwanted pressure to the coronet band or to the fetlock, which can cause severe damage to the hoof or reduced circulation. Tape and wraps lack sufficient durability and, after wearing through, allow contaminants into the treatment site.

Equine hoof care devices have been developed in attempts to address the above stated problems regarding protection of the injured hoof. Some of these devices are able to protect the hoof during treatment and some provide a durable cover for the hoof. U.S. Pat. No. 6,600,940 to Wilson discloses a hoof boot designed for treating a hoof. The Wilson treatment boot does not fully encase the hoof and only covers the sides of the hoof in order to apply treatments thereto. The hoof covering comprises an absorbent surface attached to an inner lining of the boot. Unlike the Wilson treatment boot, the present invention completely covers the hoof, including the sole, and provides for interchangeable pads to be placed under the sole of the hoof.

U.S. Pat. No. 7,762,048 B1 and U.S. Pat. No. 7,818,952 B1 to LeCompte disclose hoof boots made of natural rubber. The thickness of the boot wall incrementally increase from an elastic skin, or casing, at the top to a hoof-covering portion at the bottom. The upper casing has a beaded band providing periodically spaced rings that allow the upper casing to be cut to a selected length. The hoof-covering portion is configured to provide an inward pressure to the hoof sufficient to increase blood pressure therein. The boot, being made of rubber, is difficult to place on a hoof and must be manufactures to conform closely to the shape and size of the hoof. Unlike the boot disclosed by LeCompte, the present hoof sock is comprised of materials capable of conforming to the size and shape of a hoof and leg, making the present hoof covering easier to place on a hooves of a range of shapes and sizes.

Other commercially available hoof boots include the EZ Boot™ and the Davis Boot™. The EZ Boot™ uses a cable and buckle system to affix the boot to the hoof of the horse, making the boot difficult to affix to the hoof and potentially causing further injury by irritating the hoof and/or coronet of a horse wearing the device. The Davis Boot™ comprises a pliable upper portion that closes tightly just below the fetlock and a durable bottom made of a polyvinyl compound. The present hoof covering, unlike the above-mentioned boots, comprises a form-fitting, elastic fabric that holds the covering in place above the hoof, making the placement of the covering on the hoof and leg easier. The present hoof sock comprises a light-weight and flexible material that prevents the wearer from sensing its presence, thereby reducing the risk that the wearer will attempt to remove the hoof sock. This allows for prolonged wearing compared to existing hoof boots, which results in a longer treatment time for hoof-related ailments and injuries.

The present invention fills a continuing need for a hoof covering that allows an equine caretaker, owner, veterinarian etc., to inexpensively, reliably, and easily dress a hoof treatment site with a bandage that will protect the site from contamination, protect the hoof from injury, and remain in place until removed. The invention overcomes the above-identified imitations in prior art devices by providing for a hoof sock bandage comprising a sock that fits closely to the hoof and secures, in a form-fitting manner, on the lower leg to prevent contaminants from entering a treatment site. Additional benefits of the invention will become apparent in the following description of the invention.

### BRIEF SUMMARY OF THE INVENTION

The present invention provides for a one piece-construction sock/bandage capable of covering the hoof and lower leg of a horse, or other hoofed animal, and protecting the hoof and portions of the leg from contamination. The present invention also provides for methods for the manufacture of a one piece hoof sock bandage as well as methods for preventing and/or treating a variety of diseases, injuries, and conditions including bacterial, fungal, and viral infections, founder, laminitis, contusions, cuts, puncture wounds, and inflammation. The hoof sock additionally provides a hoof covering that prevents damage to the hoof from a variety of causes including blunt trauma, cuts, abrasions, punctures, and infections.

The present hoof sock bandage has a unitary form, one piece construction, with a hoof shaped sole cavity that has a flexible coating dipped on the sole portion. The sole cavity fits snugly to the hoof and the coating repels liquids and other contaminants from the hoof sole. The coating extends over the hoof edge and extends upwardly along the periphery of the top, past the hoof edge. The sock-like material extends from the dipped sole portion up to the area just past the fetlock. The conformed design prevents the bandage from coming off as the horse moves.

### BRIEF DESCRIPTION OF THE DRAWINGS

Like reference numerals are intended to identify the same structural elements, portions, or surfaces consistently throughout the drawings. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader.

FIGS. 1 and 2 show side and cross-section views of a first embodiment of a hoof sock bandage covering a hoof and extending up the leg to the pastern;

FIG. 3 shows a view of a second embodiment of a hoof sock bandage comprising a v-shaped split in the top portion and a fastening closure;

### DETAILED DESCRIPTION OF THE INVENTION

The hoof sock and related methods of treatments and manufacture are described herein with reference to a horse and horse-related terminology. The horse is used for the purposes of describing the preferred embodiments of the invention and is not intended that the invention be limited in scope to a horse or closely related animals such as ponies, donkeys, mules, and zebras. The invention may be modified to fit the anatomies of many other domesticated and wild, even- and odd- toed ungulate mammals including cows, bison, goats, pigs, camels, sheep, llamas, alpacas, and deer without departing from the spirit of the invention.

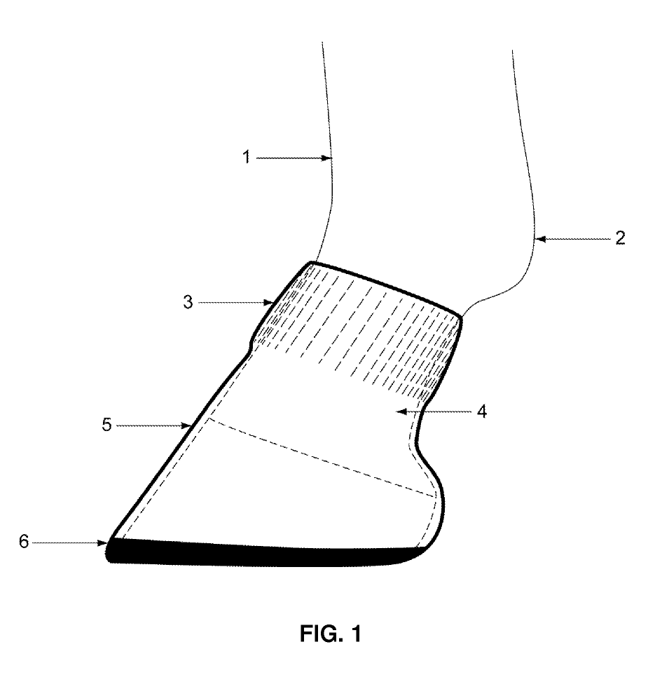

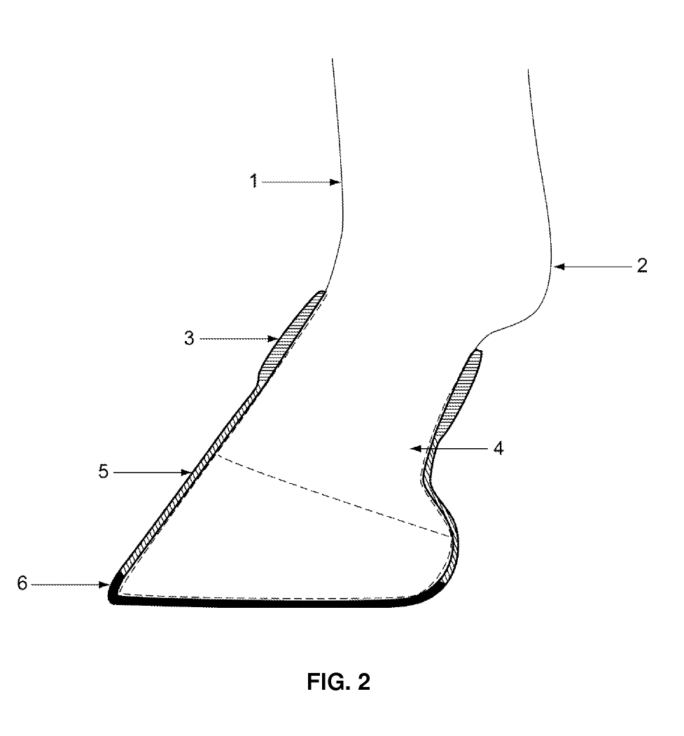

FIGS. 1 and 2 show a first embodiment of an equine hoof sock bandage on the leg 1 of a horse. The hoof sock bandage comprises an elastic sock material 5 enclosing the leg 1 from the pastern 4 down. The bottom portion of the elastic sock material comprises a coating 6 made of a durable, waterproof material that covers the bottom of the hoof and extend upward over a portion of the exterior of the hoof. The top section of the sock material 5 may be knitted or braided to form a ribbed cuff having a greater thickness and stiffness than the rest of the sock material that secures the sock to the pastern 4. The sock is preferably an elastic knit made from one or more of cotton, polyester, nylon latex, and spandex that provides 360 degrees uniform compression. Comperm LF® is one example of a preferred commercially available knit material. The coating 6 covering the bottom portion of the hoof is made by dipping the closed end of the sock material 5 in a fluid protective coating composition and forming the coated end portion of the sock material into a hoof sole cavity that fits snugly to the hoof before curing or hardening the coating composition. The coating composition is a material that forms a durable, waterproof barrier around the bottom of the hoof such as nitrile (acrylonitrile butadiene) Line-X®, or rubber. The protective coating need not be limited to covering only the sole and lower portion of the hoof wall and may cover the entire hoof wall in a continuous or discontinuous pattern. The thickness of the coating may be adjusted according to the type and weight of the animal, as well as the injury or illness being treated.

In one preferred embodiment, the equine hoof sock bandage is made from a seamless, closed Comperm LF® sock with the closed end of the sock coated with nitrile polymer having a thickness capable of providing puncture and abrasion resistance for light turnout conditions. In a particularly preferred embodiment, the coating extends over the hoof edge and upwardly along the wall of the hoof by about 1.25 cm.

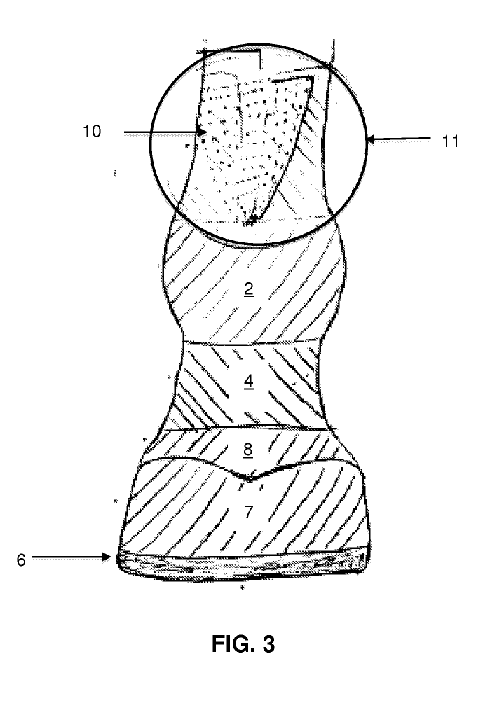

FIG. 3 shows an embodiment of an equine hoof sock bandage extending up the leg to a region 11 above the fetlock 2. The sock bandage comprising a coating 6 covering the sole of a hoof and extending up the hoof wall 7 to prevent the coated portion from slipping off of the hoof. The sock portion extends up the leg, covering the pastern 4 and fetlock 2 to a region 11 above the fetlock 2 where it is held in place by an elastic ribbed cuff as in FIG. 1 and/or by an elastic adjustable cuff comprising securing means 10. The securing means 10 may be, for example, an elastic or inelastic strap with complementary Velcro -like attachment portions, a self adhesive elastic bandage, an elastic woven band, or hook and loop closures. The securing means 10 may be an integral part of the hoof sock or be reversibly attachable thereto. The sock portion comprising the securing means 10 may include a v-shaped cut-out designed to allow the uppermost portion of the bandage to more easily fit over a hoof and to provide additional range of fit.

It is possible to form a sock bandage with different portions of the bandage manufactured or altered after manufacture to have different levels of elasticity and/or different diameters to provide closer form fitting in cases where the hoof and leg have greater dimensional variations than can be accommodated using a single sock having a single size and elasticity. Sections in FIG. 3 corresponding to anatomical regions of the hoof and leg are marked with similar “right slant” lines to indicate similar levels of elasticity and/or diameter. Sections marked with similar “left slant” lines indicate similar levels of elasticity.

A gel pad, medication and/or therapeutic agent such as an antimicrobial, anti-inflammatory agent, and therapeutic for transdermal drug delivery may be placed inside the hoof-covering and/or leg-covering portions 16,18. Alternatively or additionally, the elastic material used to make the sock bandage may be impregnated with a therapeutic agent. For example, an antimicrobial acrylic cushion may be added as padding at the heal and/or front portion of the foot portion 16 to reduce impact on the foot of the horse. In some cases, an antimicrobial material may be injected into acrylic fibers during the spinning process and bonded to the acrylic molecular structure. In a preferred embodiment, the anti-microbial compound is triclosan. Besides inhibiting growth of bacteria, fungi and yeast, such a system provides antibacterial properties which do not wash out if the sock is laundered for re-use.

An equine sock bandage 15 is made of an elastic material such as woven acrylic fibers, water-resistant polymer fibers, Kevlar, poly cotton, nylon, or combinations thereof and may comprise a blend of elastic and non-elastic fibers. In a preferred embodiment, acrylic fibers are used because of their moisture wicking properties.

The hoof sock bandage is applied by stretching the open end 20 and slipping it over the horse's hoof and onto the leg. The hoof-covering portion 6 is adjusted to fit onto the sole of the hoof with edges around the sole on the hoof wall covered by portions of the hoof-covering portion 6. The leg-covering portion is then adjusted to place the top portion of the sock material on a desired location on the lower leg such hat the elastic sock is extended to cover a portion of the lower leg in a form-fitting manner.

In the most preferred embodiments, the sock material of the hoof sock bandage provides 360 degrees of uniform compression ad support to minimize the risk of constriction and reduced circulation to the hoof and lower leg. In the most preferred embodiments, a cuff portion is sufficient to hold the device in place on the desired location on the leg and hoof with no fasteners of any kind required to hold the hoof sock bandage in place on the leg or hoof. The hoof sock bandage comprises a coated portion that forms a reinforced, durable, and waterproof hoof covering portion that, in use, seals the bottom of the hoof and at least a portion and, in some embodiments, all of the wall of the hoof. The coated, hoof covering portion of the hoof sock bandage may comprise, or be configured to contain, a medicine in a liquid, solid, suspension, or gel form and/or a medicated and/or cushioning pad.

Maladies affecting the hoof of an animal may be treated and/or prevented by placing a hoof sock bandage on a leg of a hoofed animal. In the case of treating an infection, the leg and/or hoof covering portions may comprise any of a large number of known antibiotics, antiseptics, antifungals, antivirals, and/or disinfectants. The hoof and/or leg covering portions may also comprise or contain anti-inflammatory agents, pain medicines, cooling preparations, counter irritants, steroids,

The invention has been described with the aid of drawings and examples, the use of which is not intended to limit the scope of the invention. The description is not intended to be exhaustive or to limit the invention to the form disclosed, and many modifications and variations are possible without exceeding the scope of the invention as defined by the accompanying claims.

1. A hoof sock bandage for a hoofed animal comprising:
a continuous, elastic tubular sock closed at a first end and open at a second end wherein:
said closed first end comprises a hoof-covering portion comprising a puncture resistant, waterproof, plastic coating shaped to conform to the hoof of said animal and configured to receive and enclose the sole of a hoof and at least a portion of the hoof wall of said animal;
said open second end comprises a leg covering portion configured to cover at least a portion of a leg above the hoof of said animal in a form fitting manner; and
said bandage is configured to be slipped over the hoof and a portion of the lower leg of said animal such that the hoof is contained within the hoof covering portion and the leg covering portion conforms to a portion of the lower leg of the animal.

2. The hoof sock bandage of claim 1, wherein the elastic tubular sock is a single piece of knitted, braided, or woven fabric.

3. The hoof sock bandage of claim 2, wherein said fabric comprises fibers made from the group consisting of water-resistant synthetic polymers, Kevlar, poly cotton, nylon, spandex, polyethylene and combinations thereof.

4. The hoof sock bandage of claim 1, wherein the elastic tubular sock is a seamless piece of knitted, braided, or woven fabric providing 360 degrees uniform compression.

5. The hoof sock bandage of claim 1, wherein the elastic tubular sock is water resistant or waterproof.

6. The hoof sock bandage of claim 1, wherein said open second end comprises a cuff configured to hold said open second end in place on the leg of said animal.

7. The hoof sock bandage of any of claim 1, wherein the coating has a thickness of at least 1 mm.

8. The hoof sock bandage of any of claim 1, wherein the coating is selected from the group consisting of an acrylate polymer, an acrylate copolymer, a nitrile polymer, a nitrile copolymer, Line-X®, and combinations thereof.

9. The hoof sock bandage of claim 1, wherein surface of the hoof-covering portion comprises a reinforcing material with a hardness of at least approximately 60 on the Shore D scale.

10. The hoof sock bandage of claim 1, wherein the animal is a horse and the leg-covering potion covers the pastern, the fetlock joint, and/or optionally, at least a portion of the cannon bone.

11. The hoof sock bandage of claim 10, wherein top end of the leg-covering potion comprises a cuff configured to secure to the pastern by elastically conforming to the pastern in a form fitting manner below the fetlock.

12. The hoof sock bandage of claim 1, wherein one or both of the hoof-covering portion and the tubular sock member comprises or contains a medication or a therapeutic agent.

13. A method for preventing or treating and injury to or disease affecting a hoofed animal comprising the steps of applying a hoof sock bandage according to claim 1 to the hoof and lower leg of the animal.

14. The method of clam 13, wherein the injury or disease is selected from the group consisting of a bacterial infection, a viral infection, a fungal infection, founder, laminitis, a contusion, a cut, a laceration, a puncture wound, inflammation, and combinations thereof.

15. The method of claim 14, and further comprising the step of applying a medication to an inside surface of the hoof sock bandage or to the hoof or leg of the animal before applying the hoof sock bandage to the hoof and lower leg of the animal.

16. The method of claim 15, wherein the step of applying a medication comprises placing a medicated pad in the hoof covering portion of the hoof sock bandage.

17. A method for making a hoof sock bandage comprising the steps of:
applying a reinforcing material to a first, closed end of a tube such that said reinforcing material is shaped to conform to the shape of the hoof of said animal and
hardening the reinforcing material to form a layer of reinforcing material that is at least about 1 mm thick
wherein said tube is closed at said first end and open at a second end and comprises an elastic material sufficient in length to cover the hoof and at least a portion of the lower leg in a form-fitting manner above the hoof of said animal and sufficient in diameter such that the tube can be stretched to fit over the hoof and said at least portion of the lower leg.

18. The method of claim 17, wherein said applying a reinforcing material comprises dipping the first, closed end of the tube in a liquid reinforcing material and said hardening step comprises the cooling the reinforcing material.

19. The method of claim 17, wherein said applying a reinforcing material comprises spraying a reinforcing material onto the first, closed end of the tube such that the reinforcing material conforms to a shape of a hoof.
